(19) United States
(12) Patent Application Publication
(10) Pub. No.: US 2024/0207833 A1
(43) Pub. Date: Jun. 27, 2024

(54) PHOTOCATALYST COATING LIQUID AND PHOTOCATALYST COATING LAYER

(71) Applicant: SHARP KABUSHIKI KAISHA, Sakai City (JP)

(72) Inventors: NAOKI SHIBA, Sakai City (JP); YOSHITAKA KAWASE, Sakai City (JP); TOMOYA TSUTSUMINO, Sakai City (JP); TATSUFUMI ATSUMI, Sakai City (JP); YOSHIKI KATO, Sakai City (JP)

(21) Appl. No.: 18/535,615

(22) Filed: Dec. 11, 2023

(30) Foreign Application Priority Data
Dec. 21, 2022 (JP) 2022-204616

(51) Int. Cl. B01J 35/39; B01J 23/30; B01J 35/20; B01J 37/02; B01J 37/04

(52) U.S. Cl. CPC B01J 35/39; B01J 23/30; B01J 35/20; B01J 37/0215; B01J 37/04

(57) ABSTRACT

A photocatalyst coating liquid contains photocatalyst particles containing tungsten oxide particles, copper gluconate, a dispersant, and an aqueous medium. The weight ratio (Y/X) of the copper gluconate (Y) to the photocatalyst particles (X) in the photocatalyst coating liquid is 2/100 or more and 20/100 or less.

### BACKGROUND OF THE INVENTION

### Field of the Invention

The present disclosure relates to a photocatalyst coating liquid and a photocatalyst coating layer.

### Description of the Background Art

A photocatalyst is a substance that exerts photocatalytic activity under exposure to light, and is typified by titanium oxide particles. Since titanium oxide particles exert photocatalytic activity mainly under exposure to ultraviolet light, the titanium oxide particles may not exert sufficient photocatalytic activity under indoor lighting (particularly LED lighting) that does not produce much ultraviolet light.

Since tungsten oxide has a wider light absorption band than titanium oxide and exerts photocatalytic activity even under visible light including no ultraviolet light, tungsten oxide can exert effects such as gas decomposition performance and antibacterial performance in an indoor lighting environment such as a house.

Since a photocatalyst exerts effects such as removal of volatile organic compounds (VOC) and suppression of bacteria and virus under exposure to light, the photocatalyst cannot exert the effects in an environment without light. In view of a balance between a coating amount and light intensity, it may take time to exert the effects. There is an example in which mixing the photocatalyst with another material improves a function. When a material suitable for the photocatalyst is not selected, the function of the mixed material may not be sufficiently exerted, and the performance of the photocatalyst may be inhibited.

In view of the circumstances, the present disclosure provides a photocatalyst coating liquid capable of forming a photocatalyst coating layer having excellent antibacterial performance in a dark place and excellent deodorization performance and antibacterial performance in a bright place.

### SUMMARY OF THE INVENTION

The present disclosure provides a photocatalyst coating liquid containing photocatalyst particles containing tungsten oxide particles, copper gluconate, a dispersant, and an aqueous medium. The weight ratio (Y/X) of the copper gluconate (Y) to the photocatalyst particles (X) in the photocatalyst coating liquid is 2/100 or more and 20/100 or less.

A photocatalyst coating layer formed from the photocatalyst coating liquid of the present disclosure has excellent antibacterial performance in a dark place and has excellent deodorization performance and antibacterial performance in a bright place. This has been proved by experiments conducted by the inventions of the present application.

### BRIEF DESCRIPTION OF THE DRAWINGS

FIG. 1 is a view illustrating a method for forming a photocatalyst coating layer from a photocatalyst coating liquid of the present disclosure.

FIG. 2 is a graph showing the results of an antibacterial test.

FIG. 3 is a graph showing the results of a deodorization test.

### DESCRIPTION OF THE PREFERRED EMBODIMENTS

A photocatalyst coating liquid of the present disclosure contains photocatalyst particles containing tungsten oxide particles, copper gluconate, a dispersant, and an aqueous medium. The weight ratio (Y/X) of the copper gluconate (Y) to the photocatalyst particles (X) in the photocatalyst coating liquid is 2/100 or more and 20/100 or less.

The pH of the photocatalyst coating liquid is preferably 4.5 or more and 6.5 or less.

The photocatalyst coating liquid preferably contains the copper gluconate such that the pH of a solution in which the copper gluconate is dissolved in the aqueous medium before mixing of the photocatalyst particles and the dispersant is 3.5 or more and 4.5 or less.

The average molecular weight of the dispersant is preferably 10,000 or less.

The photocatalyst coating liquid preferably contains the dispersant, the photocatalyst particles, and the copper gluconate so as to satisfy an equation: (0.8X+2Y)≤Z<1.5X, wherein X is the proportion by weight of the photocatalyst particles, Y is the proportion by weight of the copper gluconate, and Z is the proportion by weight of the dispersant, in the photocatalyst coating liquid.

The proportion by weight of the photocatalyst particles in the photocatalyst coating liquid is preferably 0.1 wt % or more and 5.0 wt % or less.

The proportion by weight of the copper gluconate in the photocatalyst coating liquid is preferably 0.01 wt % or more and 1.0 wt % or less.

The proportion by weight of the dispersant in the photocatalyst coating liquid is preferably 0.01 wt % or more and 5.0 wt % or less.

The present disclosure also provides a photocatalyst coating layer containing photocatalyst particles containing tungsten oxide particles, and copper gluconate. The weight ratio (Y/X) of the copper gluconate (Y) to the photocatalyst particles (X) in the photocatalyst coating layer is 2/100 or more and 20/100 or less.

An embodiment of the present disclosure will be described below using the drawings. The accompanying drawings and the description below merely illustrate exemplary configurations, to which the scope of the present disclosure is in no way limited.

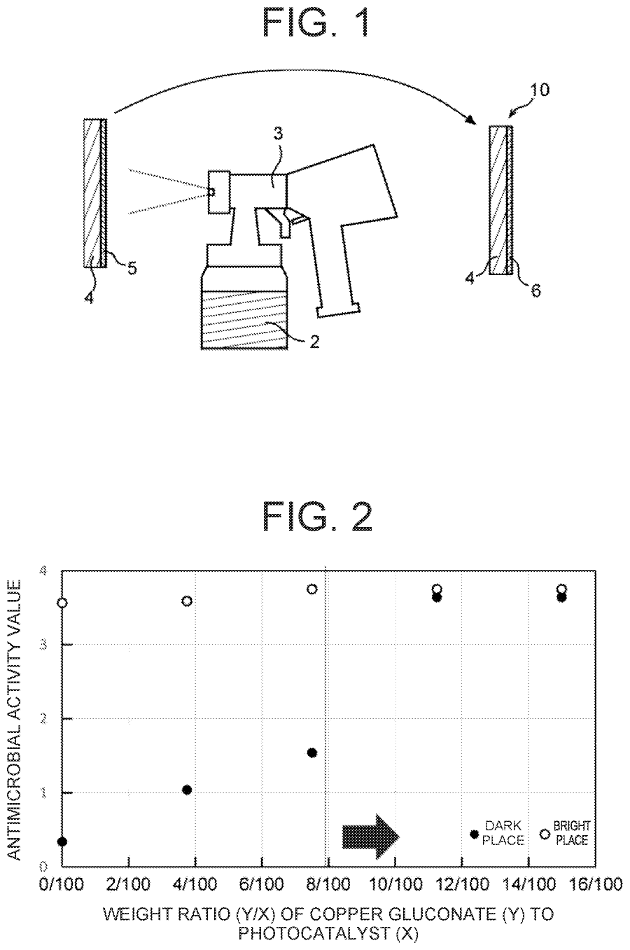

FIG. 1 is a view illustrating a method for forming a photocatalyst coating layer from a photocatalyst coating liquid of the embodiment.

A photocatalyst coating liquid 2 of the embodiment contains photocatalyst particles containing tungsten oxide particles, copper gluconate, a dispersant, and an aqueous medium. The weight ratio (Y/X) of the copper gluconate (Y) to the photocatalyst particles (X) in the photocatalyst coating liquid 2 is 2/100 or more and 20/100 or less, and preferably 8/100 or more and less than 15/100.

A photocatalyst coating layer 6 of the embodiment contains the photocatalyst particles containing tungsten oxide particles, and the copper gluconate. The weight ratio (Y/X) of the copper gluconate (Y) to the photocatalyst particles (X) in the photocatalyst coating layer is 2/100 or more and 20/100 or less, and preferably 8/100 or more and less than 15/100.

The photocatalyst coating liquid 2 is a dispersion liquid in which the photocatalyst particles are dispersed in the aqueous medium. In the aqueous medium, the copper gluconate is dissolved. The photocatalyst coating liquid 2 contains the dispersant. The photocatalyst coating liquid 2 is a dispersion liquid, with which a surface of a substrate 4 is coated by a coating method.

The pH of the photocatalyst coating liquid 2 is from 4.5 to 6.5. This configuration enables the tungsten oxide particles contained in the photocatalyst particles to stably exist in the photocatalyst coating liquid 2.

In a method for producing the photocatalyst coating liquid 2, for example, the copper gluconate is dissolved in the aqueous medium, and to this solution, the photocatalyst particles and the dispersant are added, resulting in fine dispersion of the photocatalyst particles. The photocatalyst particles may be diluted with a solvent in advance, if needed. The photocatalyst particles can be generally dispersed in water with a wet dispersion machine (such as an ultrasonic dispersion machine, a colloid mill, and a bead mill). In mixing, a typical liquid mixer can be used. A liquid mixer provided with a stirring blade and the like makes it possible to achieve a more uniform composition of the photocatalyst coating liquid 2.

A method for applying the photocatalyst coating liquid 2 is not particularly limited, and examples thereof include spray coating, bar coating, brush coating, dip coating, screen printing, spin coating, and roll coating. For example, a coating film 5 formed by applying the photocatalyst coating liquid 2 to the surface of the substrate 4 by spray coating can be dried to form the photocatalyst coating layer 6, as illustrated in FIG. 1. A photocatalyst coated member 10 having the photocatalyst coating layer 6 can be also formed. The photocatalyst coating layer 6 formed by applying the photocatalyst coating liquid 2 followed by drying is irradiated with light, to exert a photocatalytic effect such as deodorization and suppression of bacteria. In applying the photocatalyst coating liquid 2, an electric spray gun (for example, a manual spray 3) is preferably used, and a HVLP gun or the like is more preferably used. By this configuration, the photocatalyst coating liquid 2 can be finely, thinly, uniformly, and unevenly applied to the substrate 4.

The substrate 4 is, for example, a wallpaper, a curtain, an inner wall of a building, an exterior wall of a building, a ceiling of a room, a floor surface of a building, furniture, a window, glass, plastic, metal, ceramics, wood, stone, cement, concrete, fibers, a filter, a cloth, paper, or leather.

The aqueous medium contains water as a main component. The aqueous medium may be a mixed solution of water and alcohol (for example, ethanol). The proportion of water in the aqueous medium is, for example, 30 wt % or more and 100 wt % or less. The proportion of alcohol in the aqueous medium is, for example, 1 wt % or more and 70 wt % or less. The aqueous medium may contain ethyl acetate.

The photocatalyst particles are particles that exhibit photocatalytic activity under exposure to light and contain tungsten oxide particles (WO₃ particles). The photocatalyst particles can exert effects such as decomposition of an organic substance under irradiation with light. Since the photocatalyst coating layer 6 contains the photocatalyst particles, the photocatalyst coating layer 6 may have deodorization performance, antibacterial performance, antiviral performance, and the like.

The photocatalyst particles mainly contain tungsten oxide (WO₃). The tungsten oxide particles may be those having a composition deviated from a stoichiometric composition as long as they have photocatalytic activity. The tungsten oxide particles may contain an impurity atom or an additive atom within a range where photocatalytic activity is not deteriorated. The proportion by weight of the photocatalyst particles in the photocatalyst coating liquid 2 is, for example, 0.1 wt % or more and 5.0 wt % or less, and preferably 0.2 wt % or more and 1.2 wt % or less. This configuration makes it possible to impart excellent photocatalytic activity to the photocatalyst coating layer 6 and to suppress the coloration of the photocatalyst coating layer 6 that is caused by the aggregation of the photocatalyst particles.

The photocatalyst particles may be those in which a promoter is supported on the WO₃ particles. The promoter is preferably a platinum group metal such as Pt, Pd, Rh, Ru, Os, or Ir. The 50% volume accumulation diameter (primary particle diameter) of the photocatalyst particles is preferably 1 nm or more and 500 nm or less. When the 50% volume accumulation diameter is 5 nm or more, the photocatalyst particles less aggregate in the photocatalyst coating liquid 2 and are easily re-dispersed. A 50% volume accumulation diameter of the photocatalyst particles of 200 nm or less is favorable since the photocatalyst particles tend to be uniformly mixed with another component in a step of preparing the photocatalyst coating liquid 2, and detachment hardly occurs. The particle diameter can be measured with a BET specific surface area meter, a laser diffraction particle size distribution meter, a dynamic light-scattering distribution meter, or the like.

The copper gluconate is a water-soluble copper compound and is a copper salt of gluconic acid. The molecular formula of the copper gluconate is C₁₂H₂₂CuO₁₄. Although most of copper-related compound is generally classified as a hazardous substance, the copper gluconate is not classified as a hazardous substance and is a highly safe chemical that is specified as a food additive. When the copper gluconate is dissolved in the aqueous medium, copper ions are generated, and the resulting solution is blue.

When the photocatalyst coating liquid 2 containing copper gluconate is applied, the photocatalyst coating layer 6 containing copper gluconate or a decomposed product thereof can be formed. Since copper ions contained in the copper gluconate or the decomposed product thereof have an antibacterial action, the antibacterial performance of the photocatalyst coating layer 6 can be enhanced.

Since the photocatalytic activity of the photocatalyst particles occurs under exposure of the photocatalyst particles to light, the antibacterial action based on the photocatalytic activity cannot be expected in a dark place. However, the photocatalyst coating layer 6 contains the copper gluconate or the decomposed product thereof, and therefore the photocatalyst coating layer 6 can have antibacterial performance in a dark place. Due to a synergistic effect between the copper ions and the photocatalytic activity, the antibacterial action in a bright place can be enhanced.

When the proportion by weight of the copper gluconate in the photocatalyst coating liquid 2 is 0.01 wt % or more and 1.0 wt % or less, preferably 0.03 wt % or more and 0.5 wt % or less, and more preferably 0.05 wt % or more and 0.2 wt % or less. This configuration makes it possible to impart both excellent antibacterial performance and excellent deodorization performance to the photocatalyst coating layer 6. Further, the coloration of the photocatalyst coating layer 6 can be suppressed.

The photocatalyst coating liquid 2 may contain the copper gluconate such that the pH of a solution in which the copper gluconate is dissolved in the aqueous medium before mixing of the photocatalyst particles and the dispersant is 3.5 or more and 4.5 or less. This configuration enables the pH of the photocatalyst coating liquid 2 to be kept to from 4.5 to 6.5 and enables the tungsten oxide particles contained in the photocatalyst particles to stably exist in the photocatalyst coating liquid 2.

The weight ratio (Y/X) of the copper gluconate (Y) to the photocatalyst particles (X) in the photocatalyst coating liquid 2 is 2/100 or more, and preferably 8/100 or more. This configuration makes it possible to impart excellent antibacterial performance in a dark place to the photocatalyst coating layer 6. Due to the synergistic effect between the photocatalytic activity and the antibacterial action of copper ions, the antibacterial action of the photocatalyst coating layer 6 in a bright place can be enhanced.

The weight ratio (Y/X) of the copper gluconate (Y) to the photocatalyst particles (X) in the photocatalyst coating liquid 2 is 20/100 or less, and preferably less than 15/100. This configuration makes it possible to suppress the inhibition of deodorization performance of the photocatalyst coating layer 6 by the copper gluconate and to impart excellent deodorization performance in a bright place to the photocatalyst coating layer 6. Further, the coloration of the photocatalyst coating layer 6 can be suppressed.

The dispersant is a component for dispersing the photocatalyst particles in the aqueous medium. Since the photocatalyst coating liquid 2 contains the dispersant, the dispersibility of the photocatalyst particles in the aqueous medium can be enhanced. The dispersant can enhance the dispersibility due to an increase in electrostatic repulsion and the steric hindrance of a polymer chain. The dispersant is, for example, an amine compound or an aliphatic amide compound. Since the photocatalyst coating liquid 2 contains the dispersant, liquid droplets and the photocatalyst particles dried in air during the spraying of the photocatalyst coating liquid 2 are unlikely to be excessively charged. This can prevent whitening of the surface of an electrostatically charged substance to which the photocatalyst particles are excessively concentrated and attached at the spraying area. In addition, the dispersant contained in the photocatalyst coating liquid 2 can suppress a decrease in the dispersibility of the photocatalyst particles that is caused by the copper ions.

The dispersant in the photocatalyst coating layer 6 is decomposed by the photocatalytic activity. Therefore, the deodorization performance and the like of the photocatalyst coating layer 6 are decreased while the dispersant is decomposed by the photocatalytic activity. Accordingly, the dispersant is preferably one capable of being dispersed by the photocatalytic activity in a relatively short time.

The average molecular weight of the dispersant is preferably 100 or more and 10,000 or less, and more preferably 200 or more and less than 6,000. This configuration makes it possible to decompose the dispersant by the photocatalytic activity in a relatively short time and to suppress long-time inhibition of photocatalytic activity by the dispersant. When the molecular weight of the dispersant is too small, volatility is high, the sprayed liquid droplets are dried and solidified in air before contact with a wall, and as a result, an effect of preventing whitening is deteriorated. When the molecular weight of the dispersant is too large, it takes time to decompose the dispersant around the photocatalyst particles, which are to mainly decompose an organic substance around the photocatalyst particles after application. Immediately after application, a speed at which the photocatalyst particles exert an effect on the decomposition of an organic gas in air may be decreased.

Examples of the dispersant usable in the embodiment include an anionic surfactant (anionic dispersant), a nonionic surfactant (nonionic dispersant), a cationic surfactant (cationic dispersant), an amphoteric surfactant (amphoteric dispersant), an aliphatic polyether derivative, and a polyethylene glycol.

Examples of the anionic surfactant include alkyl sulfates, polyoxyethylene alkyl ether sulfates, alkyl benzene sulfonates, alkyl naphthalene sulfonates, alkyl sulfosuccinates, alkyl diphenyl ether disulfonates, naphthalene sulfonate formaldehyde condensates, polyoxyethylene polycyclic phenyl ether sulfates, polyoxyethylene distyrenated phenyl ether sulfates, fatty acid salts, alkyl phosphates, and polyoxyethylene alkyl phenyl ether sulfates.

Examples of the nonionic surfactant include polyoxyethylene alkyl ethers, polyoxyalkylene alkyl ethers, polyoxyethylene polycyclic phenyl ethers, polyoxyethylene distyrenated phenyl ethers, sorbitan fatty acid esters, polyoxyethylene sorbitan fatty acid esters, polyoxyethylene sorbitol fatty acid esters, glycerol fatty acid esters, polyoxyethylene fatty acid esters, polyoxyethylene alkylamines, alkyl alkanolamides, and polyoxyethylene alkyl phenyl ethers. Examples of the cationic surfactant include quaternary ammonium salts such as alkyl trimethylammonium bromide, alkyl pyridinium bromide, and imidazolinium laurate, pyridinium salts, and imidazolinium salts.

Examples of the amphoteric surfactant include lauryl betaine and lauryl dimethyl amine oxide. Among these, a polyethylene glycol and an amine compound having a polyoxyalkylene group are more preferable since they do not significantly inhibit the performance of a photocatalyst and are excellent in dispersibility.

The proportion by weight of the dispersant in the photocatalyst coating liquid 2 is, for example, 0.01 wt % or more and 5.0 wt % or less, preferably 0.2 wt % or more and 3.0 wt % or less, and more preferably 0.4 wt % or more and 1.5 wt % or less. This configuration makes it to sufficiently disperse the photocatalyst particles in the photocatalyst coating liquid 2, to suppress the aggregation and precipitation of the photocatalyst particles, and to decompose the dispersant in the photocatalyst coating layer 6 by the photocatalytic activity in a relatively short time.

The photocatalyst coating liquid 2 preferably contains the dispersant, the photocatalyst particles, and the copper gluconate so as to satisfy an equation: (0.8X+2Y)≤Z<1.5X, wherein X is the proportion by weight of the photocatalyst particles, Y is the proportion by weight of the copper gluconate, and Z is the proportion by weight of the dispersant, in the photocatalyst coating liquid 2.

When the proportion by weight Z of the dispersant in the photocatalyst coating liquid 2 is equal to or more than a value calculated using an expression: 0.8X+2Y (0.8X+2Y≤Z), the photocatalyst coating liquid can have excellent dispersibility.

When the proportion by weight Z of the dispersant in the photocatalyst coating liquid 2 is less than a value (1.5X) obtained by multiplying the proportion by weight X of the photocatalyst particles by 1.5 (Z<1.5X), the dispersant decomposition time can be shortened, and the photocatalyst coating layer 6 can exert deodorization performance relatively fast.

### Preparation of Photocatalyst Coating Liquid

Among tungsten oxide powder (photocatalyst particles) as a photocatalyst, copper gluconate, a dispersant, and pure water, components listed in Table 1 were mixed at a composition listed in Table 1 and stirred, resulting in dispersion. Thus, photocatalyst coating liquids in Examples 1 to 19 and Comparative Examples 1 to 5 were prepared. The pHs of the photocatalyst coating liquids in Examples 1 to 19 were about 5.5. The pH of a copper gluconate aqueous solution used in the preparation of the photocatalyst coating liquids in Examples 1 to 19 was about 4.0. As the dispersant, “ESLEAM” available from NOF CORPORATION was used. This dispersant was a polyoxyalkylene group-containing compound and had a molecular weight of 100 to 10,000.

Copper gluconate (molecular weight: 453.84) that was a water-soluble copper compound was light blue powder, and the proportion of copper in the copper gluconate was about 14 wt %. Table 1 also shows the weight ratio Z/X of a dispersant Z to photocatalyst particles X in the respective photocatalyst coating liquids and the weight ratio Y/X of copper gluconate Y to the photocatalyst particles X in the photocatalyst coating liquids.

TABLE 1

| | Composition | | | | | Weight ratio |
|---|---|---|---|---|---|---|
| | Photocatalyst | Copper | | | Weight ratio | (copper |
| | particles | gluconate | Dispersant | Pure | (dispersant Z/ | gluconate Y/ |
| | X | Y | Z | water | photocatalyst X) | photocatalyst X) |
| Comparative | 0.5 wt % | 0.00 wt % | 0.00 wt % | 99.50 wt % | 0/100 | 0/100 |
| Example 1 | | | | | | |
| Comparative | 0.5 wt % | 0.00 wt % | 1.00 wt % | 98.50 wt % | 200/100 | 0/100 |
| Example 2 | | | | | | |
| Comparative | 0.5 wt % | 0.00 wt % | 0.38 wt % | 99.12 wt % | 75/100 | 0/100 |
| Example 3 | | | | | | |
| Comparative | 0.5 wt % | 0.00 wt % | 0.44 wt % | 99.06 wt % | 88/100 | 0/100 |
| Example 4 | | | | | | |
| Comparative | 0.5 wt % | 0.05 wt % | 0.00 wt % | 99.45 wt % | 0/100 | 10/100 |
| Example 5 | | | | | | |
| Example 1 | 0.5 wt % | 0.02 wt % | 1.00 wt % | 98.48 wt % | 200/100 | 3.8/100 |
| Example 2 | 0.5 wt % | 0.04 wt % | 1.00 wt % | 98.46 wt % | 200/100 | 7.5/100 |
| Example 3 | 0.5 wt % | 0.06 wt % | 1.00 wt % | 98.44 wt % | 200/100 | 11.3/100 |
| Example 4 | 0.5 wt % | 0.08 wt % | 1.00 wt % | 98.42 wt % | 200/100 | 15.0/100 |
| Example 5 | 0.5 wt % | 0.01 wt % | 1.00 wt % | 98.49 wt % | 200/100 | 2.6/100 |
| Example 6 | 0.5 wt % | 0.03 wt % | 1.00 wt % | 98.47 wt % | 200/100 | 5.2/100 |
| Example 7 | 0.5 wt % | 0.04 wt % | 1.00 wt % | 98.46 wt % | 200/100 | 7.8/100 |
| Example 8 | 0.5 wt % | 0.05 wt % | 1.00 wt % | 98.45 wt % | 200/100 | 10.5/100 |
| Example 9 | 0.5 wt % | 0.09 wt % | 1.00 wt % | 98.41 wt % | 200/100 | 18.4/100 |
| Example 10 | 0.5 wt % | 0.06 wt % | 0.38 wt % | 99.06 wt % | 75/100 | 11.3/100 |
| Example 11 | 0.5 wt % | 0.04 wt % | 0.44 wt % | 99.02 wt % | 88/100 | 7.5/100 |
| Example 12 | 0.5 wt % | 0.05 wt % | 0.44 wt % | 99.01 wt % | 88/100 | 9.4/100 |
| Example 13 | 0.5 wt % | 0.06 wt % | 0.44 wt % | 99.00 wt % | 88/100 | 11.3/100 |
| Example 14 | 0.5 wt % | 0.04 wt % | 0.50 wt % | 98.96 wt % | 100/100 | 7.5/100 |
| Example 15 | 0.5 wt % | 0.05 wt % | 0.50 wt % | 98.95 wt % | 100/100 | 9.4/100 |
| Example 16 | 0.5 wt % | 0.06 wt % | 0.50 wt % | 98.94 wt % | 100/100 | 11.3/100 |
| Example 17 | 0.5 wt % | 0.05 wt % | 0.25 wt % | 99.20 wt % | 50/100 | 10/100 |
| Example 18 | 0.5 wt % | 0.05 wt % | 0.50 wt % | 98.95 wt % | 100/100 | 10/100 |
| Example 19 | 0.5 wt % | 0.05 wt % | 0.75 wt % | 98.70 wt % | 150/100 | 10/100 |

### Antibacterial Test

A sample was produced by applying the photocatalyst coating liquid in each of Examples 1 to 19 and Comparative Examples 1 to 5 to a cellulose nonwoven fabric such that the amount of the photocatalyst particles was 0.02 g/m², and the antibacterial activity value in a dark place (24 hours) and a bright place (24 hours, 500 1×) of the sample was measured by a method in accordance with JIS R1752:2020. Table 2 shows the measurement results and evaluation. In the evaluation of antibacterial performance in Table 2, the evaluation of photocatalyst coating liquid in which the antibacterial activity value was 3 or more is expressed as “excellent”, the evaluation of photocatalyst coating liquid in which the antibacterial activity value was 2 or more and less than 3 is expressed as “good”, the evaluation of photocatalyst coating liquid in which the antibacterial activity value was 1 or more and less than 2 is expressed as “fair”, and the evaluation of photocatalyst coating liquid in which the antibacterial activity value was less than 1 is expressed as “poor”. The evaluation of “excellent”, “good”, or “fair” was determined to be an allowable level (be excellent in antibacterial properties).

FIG. 2 is a group in which the horizontal axis is the weight ratio (Y/X) of the copper gluconate (Y) to the photocatalyst particles (X) in the photocatalyst coating liquid and the longitudinal axis is the antibacterial activity value, and that shows the measurement results in Comparative Example 2 and Examples 1 to 4.

TABLE 2

| | Weight ratio | Antibacterial performance | | | Deodorization | | | Evaluation of |
|---|---|---|---|---|---|---|---|---|
| | (copper | Antibacterial | | | performance | | | dispersant |
| | gluconate Y/ | activity value | Evaluation | Evaluation | Acetaldehyde | Evaluation | Evaluation of | decomposition |
| | photocatalyst X) | (dark place) | (dark place) | (bright place) | residual rate | (bright place) | dispersibility | time |
| Comparative | 0/100 | 0.21 | Poor | Fair | 0.0% | Excellent | Fair | — |
| Example 1 | | | | | | | | |
| Comparative | 0/100 | 0.34 | Poor | Excellent | 0.0% | Excellent | Excellent | Fair |
| Example 2 | | | | | | | | |
| Comparative | 0/100 | 0.34 | Poor | Excellent | 0.0% | Excellent | Fair | Fair |
| Example 3 | | | | | | | | |
| Comparative | 0/100 | 0.34 | Poor | Excellent | 0.0% | Excellent | Good | Fair |
| Example 4 | | | | | | | | |
| Comparative | 10/100 | 3.28 | Excellent | Excellent | 13.0% | Good | Poor | — |
| Example 5 | | | | | | | | |
| Example 1 | 3.8/100 | 1.04 | Fair | Excellent | 6.0% | Good | Good | Fair |
| Example 2 | 7.5/100 | 1.54 | Fair | Excellent | 10.0% | Good | Good | Fair |
| Example 3 | 11.3/100 | 3.64 | Excellent | Excellent | 15.0% | Good | Good | Fair |
| Example 4 | 15.0/100 | 3.64 | Excellent | Excellent | 41.0% | Fair | Good | Fair |
| Example 5 | 2.6/100 | 1.0 | Fair | Excellent | 6.0% | Good | Good | Fair |
| Example 6 | 5.2/100 | 1.31 | Fair | Excellent | 6.0% | Good | Good | Fair |
| Example 7 | 7.8/100 | 1.55 | Fair | Excellent | 10.0% | Good | Good | Fair |
| Example 8 | 10.5/100 | 2.5 | Good | Excellent | 14.0% | Good | Good | Fair |
| Example 9 | 18.4/100 | 3.64 | Excellent | Excellent | 45.0% | Fair | Good | Fair |
| Example 10 | 11.3/100 | 3.64 | Excellent | Excellent | 15.0% | Good | Fair | Good |
| Example 11 | 7.5/100 | 1.54 | Fair | Excellent | 10.0% | Good | Fair | Good |
| Example 12 | 9.4/100 | 2.35 | Good | Excellent | 15.0% | Good | Fair | Good |
| Example 13 | 11.3/100 | 3.64 | Excellent | Excellent | 15.0% | Good | Fair | Good |
| Example 14 | 7.5/100 | 1.54 | Fair | Excellent | 10.0% | Good | Good | Good |
| Example 15 | 9.4/100 | 2.35 | Good | Excellent | 15.0% | Good | Good | Good |
| Example 16 | 11.3/100 | 3.64 | Excellent | Excellent | 15.0% | Good | Fair | Good |
| Example 17 | 10/100 | 3.28 | Excellent | Excellent | 13.0% | Good | Fair | Good |
| Example 18 | 10/100 | 3.28 | Excellent | Excellent | 13.0% | Good | Good | Good |
| Example 19 | 10/100 | 3.28 | Excellent | Excellent | 13.0% | Good | Good | Fair |

As shown in the graph of FIG. 2, as the weight ratio (Y/X) is larger, the antibacterial activity value in a dark place is larger. The results show that when the weight ratio (Y/X) is 8/100 or more, the photocatalyst coating liquid has a sufficiently high antibacterial activity value. Since the photocatalytic activity does not occur in the dark place, the antibacterial activity in the dark place is estimated to be based on the copper gluconate.

### Deodorization Test

The photocatalyst coating liquid in each of Comparative Examples 1 to 5 and Examples 1 to 19 was dropped on the whole of cellulose unwoven fabric (12.5 cm cube) with a dropper such that the amount of photocatalyst particles was 0.4 g/m², to form a coating film on the surface of the unwoven fabric. The coating film was dried, to form a photocatalyst coating layer. This nonwoven fabric with the photocatalyst coating layer was pre-irradiated with blue LED light (4,500 1×) for 48 hours, to produce a sample for a deodorization test. The produced sample was placed in a 1-L gas bag, and 50 ppm of acetaldehyde gas was then injected into the gas bag. The sample in the gas bag was irradiated with blue LED light (4,500 1×) for 1 hour, and the acetaldehyde concentration in the gas bag was measured using a detector tube. The acetaldehyde residual rate was calculated by the following expression.

$$Acetaldehyde residual rate ( \% ) = ( acetaldehyde concentration after irradiation with blue light ) / ( initital acetaldehyde concentration ( 50 ppm ) ) \times 100$$

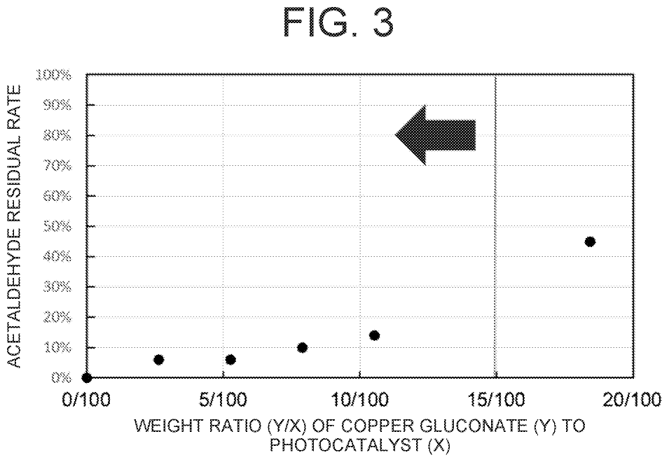

Table 2 shows the measurement results and evaluation. In the evaluation of deodorization performance, the evaluation of the photocatalyst coating liquid (photocatalyst coating layer) in which the acetaldehyde residual rate was 5% or less is expressed as “excellent”, the evaluation of the photocatalyst coating liquid (photocatalyst coating layer) in which the acetaldehyde residual rate was from 5 to 20% is expressed as “good”, and the evaluation of the photocatalyst coating liquid (photocatalyst coating layer) in which the acetaldehyde residual rate was from 20 to 90% is expressed as “fair”. The evaluation of the photocatalyst coating liquid (photocatalyst coating layer) in which the acetaldehyde residual rate was from 90 to 100% is expressed as “poor”, but the photocatalyst coating liquid that meets this evaluation was not found. FIG. 3 is a group in which the horizontal axis is the weight ratio (Y/X) of the copper gluconate (Y) to the photocatalyst particles (X) in the photocatalyst coating liquid and the longitudinal axis is the acetaldehyde residual rate, and that shows the measurement results in Comparative Example 2 and Examples 5 to 9.

As seen from Table 2 and the group in FIG. 3, when the weight ratio (Y/X) is smaller than 15/100, the acetaldehyde residual rate is 20% or less. This is considered to be because when the weight ratio (Y/X) of the copper gluconate (Y) to the photocatalyst particles (X) is large, the photocatalytic activity of the photocatalyst particles is inhibited.

As seen from the results of the antibacterial test and the results of the deodorization performance measurement, when the weight ratio (Y/X) of the copper gluconate (Y) to the photocatalyst particles (X) in the photocatalyst coating liquid is 8/100 or more and less than 15/100, the photocatalyst coating layer formed from the photocatalyst coating liquid can have excellent antibacterial performance in a dark place and excellent deodorization performance and antibacterial performance in a bright place.

### Evaluation of Dispersibility of Photocatalyst Coating Liquid

The prepared photocatalyst coating liquid was stood, an aggregation-precipitation state was observed, and the dispersibility of the photocatalyst coating liquid was evaluated. The evaluation results of dispersibility are shown in Table 2. In Table 2, the evaluation of the photocatalyst coating liquid in which aggregation and precipitation were not observed at normal temperature for 24 hours even after the photocatalyst coating liquid was stood is expressed as “good”, and the evaluation of the photocatalyst coating liquid in which aggregation and precipitation were observed at normal temperature within some hours is expressed as “fair”. The evaluation of the photocatalyst coating liquid in which aggregation and precipitation were observed immediately after the photocatalyst coating liquid was stood is expressed as “poor”.

Table 3 shows the proportion by weight X of the photocatalyst particles, the proportion by weight Y of the copper gluconate, the proportion by weight Z of the dispersant, and the evaluation of the dispersant, in the photocatalyst coating liquids in Examples 10 to 16 and Comparative Examples 3 and 4. Table 3 shows values calculated using the expression: 0.8X+2Y. Table 3 also shows the weight ratio Z/X of the dispersant Z to the photocatalyst particles X and the weight ratio Y/X of the copper gluconate Y to the photocatalyst particles X, in the photocatalyst coating liquids in Examples 10 to 16 and Comparative Examples 3 and 4.

TABLE 3

| | | | | | Weight ratio | | |
|---|---|---|---|---|---|---|---|
| | Photocatalyst | Copper | | | (copper | Weight ratio | |
| | particles | gluconate | | Dispersant | gluconate Y/ | (dispersant Z/ | Evaluation of |
| | X | Y | 0.8X + 2Y | Z | photocatalyst X) | photocatalyst X) | dispersibility |
| Comparative | 0.5 wt % | 0.00 wt % | 0.4 | 0.38 wt % | 0./100 | 75/100 | Fair |
| Example 3 | | | | | | | |
| Example 10 | 0.5 wt % | 0.06 wt % | 0.52 | 0.38 wt % | 11.25/100 | 75/100 | Fair |
| Comparative | 0.5 wt % | 0.00 wt % | 0.4 | 0.44 wt % | 0/100 | 88/100 | Good |
| Example 4 | | | | | | | |
| Example 11 | 0.5 wt % | 0.04 wt % | 0.48 | 0.44 wt % | 7.5/100 | 88/100 | Fair |
| Example 12 | 0.5 wt % | 0.05 wt % | 0.5 | 0.44 wt % | 9.38/100 | 88/100 | Fair |
| Example 13 | 0.5 wt % | 0.06 wt % | 0.52 | 0.44 wt % | 11.25/100 | 88/100 | Fair |
| Example 14 | 0.5 wt % | 0.04 wt % | 0.48 | 0.50 wt % | 7.5/100 | 100/100 | Good |
| Example 15 | 0.5 wt % | 0.05 wt % | 0.5 | 0.50 wt % | 9.38/100 | 100/100 | Good |
| Example 16 | 0.5 wt % | 0.06 wt % | 0.52 | 0.50 wt % | 11.25/100 | 100/100 | Fair |

The evaluation results listed in Tables 2 and 3 show that when the proportion by weight Z of the dispersant in the photocatalyst coating liquid is equal to or more than the value calculated using the expression: 0.8X+2Y (0.8X+2Y≤ Z), the photocatalyst coating liquid has excellent dispersibility.

### Evaluation of Dispersant Decomposition Time

The photocatalyst coating liquid in each of Comparative Examples 2 to 4 and Examples 1 to 19 was dropped on the whole of cellulose unwoven fabric (12.5 cm cube) with a dropper such that the amount of photocatalyst particles was 0.4 g/m², to form a coating film on the surface of the unwoven fabric. The coating film was dried, to form a photocatalyst coating layer. Thus, a sample for measurement of dispersant decomposition time was prepared. Pre-irradiation was not carried out. The produced sample was placed in a 1-L gas bag, and 50 ppm of acetaldehyde gas was then injected into the gas bag. The sample in the gas bag was irradiated with blue LED light (4,500 1×) for 2 hours or 4 hours, and the acetaldehyde gas concentration in the gas bag was measured using a detector tube (manufactured by GASTEC CORPORATION). The measurement was carried out for each irradiation time. The acetaldehyde residual rate was calculated by the following expression.

$$Acetaldehyde residual rate ( \% ) = ( acetaldehyde concentration after irradiation with blue light ) / ( initital acetaldehyde concentration ( 50 ppm ) ) \times 100$$

The irradiation time when the acetaldehyde residual rate was 80% or less is called dispersant decomposition time.

Table 2 shows the evaluation of dispersant decomposition time. In the evaluation of dispersant decomposition time, the evaluation of the photocatalyst coating liquid (photocatalyst coating layer) in which the dispersant decomposition time was 2 hours or less is expressed as “good”, and the evaluation of the photocatalyst coating liquid (photocatalyst coating layer) in which the dispersant decomposition time was more than 2 hours and 4 hours or less is expressed as “fair”. The evaluation of the photocatalyst coating liquid (photocatalyst coating layer) in which the dispersant decomposition time was more than 4 hours is expressed as “poor”, but the photocatalyst coating liquid that meets this evaluation was not found.

Table 4 shows the proportion by weight X of the photocatalyst particles, the proportion by weight Z of the dispersant, the value (1.5X) obtained by multiplying the proportion by weight X by 1.5, and the evaluation of the dispersant decomposition time, in the photocatalyst coating liquids in Examples 17 to 19. In addition, Table 4 shows the proportion by weight X of the photocatalyst particles, the proportion by weight Z of the dispersant, and the value (1.5X) obtained by multiplying the proportion by weight X by 1.5 in the photocatalyst coating liquid, in Comparative Example 5.

TABLE 4

| | | | | Evaluation of |
|---|---|---|---|---|
| | Photocatalyst | | Dispersant | dispersant |
| | particles X | 1.5X | Z | decomposition time |
| Comparative | 0.5 wt % | 0.75 | 0.00 wt % | — |
| Example 5 | | | | |
| Example 17 | 0.5 wt % | 0.75 | 0.25 wt % | Good |
| Example 18 | 0.5 wt % | 0.75 | 0.50 wt % | Good |
| Example 19 | 0.5 wt % | 0.75 | 0.7 wt % | Fair |

The evaluation results listed in Tables 2 and 4 show that when the proportion by weight Z of the dispersant is less than the value (1.5X) obtained by multiplying the proportion by weight X of the photocatalyst particles by 1.5 (Z<1.5X), the dispersant decomposition time can be shortened, and the photocatalyst coating layer can exert deodorization performance relatively fast.

The evaluation of dispersibility of the photocatalyst coating liquid and the evaluation of dispersant decomposition time show that when the proportion by weight Z of the dispersant in the photocatalyst coating liquid is equal to or more than the value calculated using the expression: 0.8X+2Y and is smaller than the value (1.5X) obtained by multiplying the proportion by weight X of the photocatalyst particles by 1.5 (0.8X+2Y≤Z<1.5X), the photocatalyst coating liquid can have excellent dispersibility, and the photocatalyst coating layer can exert deodorization performance relatively fast.

What is claimed is:

1. A photocatalyst coating liquid comprising:
photocatalyst particles containing tungsten oxide particles;
copper gluconate;
a dispersant; and
an aqueous medium,
a weight ratio (Y/X) of the copper gluconate (Y) to the photocatalyst particles (X) being 2/100 or more and 20/100 or less.

2. The photocatalyst coating liquid according to claim 1, wherein the photocatalyst coating liquid has a pH of 4.5 or more and 6.5 or less.

3. The photocatalyst coating liquid according to claim 1, wherein the copper gluconate is contained such that a solution in which the copper gluconate is dissolved in the aqueous medium before mixing of the photocatalyst particles and the dispersant has a pH of 3.5 or more and 4.5 or less.

4. The photocatalyst coating liquid according to claim 1, wherein an average molecular weight of the dispersant is 10,000 or less.

5. The photocatalyst coating liquid according to claim 1, wherein the dispersant, the photocatalyst particles, and the copper gluconate are contained so as to satisfy an equation: (0.8X+2Y)≤Z<1.5X, wherein X is a proportion by weight of the photocatalyst particles, Y is a proportion by weight of the copper gluconate, and Z is a proportion by weight of the dispersant, in the photocatalyst coating liquid.

6. The photocatalyst coating liquid according to claim 1, wherein the proportion by weight of the photocatalyst particles in the photocatalyst coating liquid is 0.1 wt % or more and 5.0 wt % or less.

7. The photocatalyst coating liquid according to claim 1, wherein the proportion by weight of the copper gluconate in the photocatalyst coating liquid is 0.01 wt % or more and 1.0 wt % or less.

8. The photocatalyst coating liquid according to claim 1, wherein a proportion by weight of the dispersant in the photocatalyst coating liquid is 0.01 wt % or more and 5.0 wt % or less.

9. A photocatalyst coating layer comprising:
photocatalyst particles containing tungsten oxide particles; and
copper gluconate,
a weight ratio (Y/X) of the copper gluconate (Y) to the photocatalyst particles (X) being 2/100 or more and 20/100 or less.
